(19) United States
(12) Patent Application Publication
(10) Pub. No.: US 2002/0010581 A1
(43) Pub. Date: Jan. 24, 2002

(54) Voice recognition device

(76) Inventors: Stephan Euler, Darmstadt (DE); Andreas Korthauer, Stuttgart (DE)

Correspondence Address: Richard L. Mayer, Esq., Kenyon & Kenyon, One Broadway, New York, NY, 10004, US

(21) Appl. No.: 09/880,315

(22) Filed: Jun. 13, 2001

(30) Foreign Application Priority Data
Jun. 19, 2000 (DE) 1 00 30 105.3

(51) Int. Cl. G10L 19/02; G10L 21/00; G10L 15/12; G10L 15/08

(52) U.S. Cl. 704/236; 704/203

(57) ABSTRACT

A voice recognition device, where at least two input signals are routed in parallel via respective, separate channels to a recognition device having a feature extraction device for forming feature vectors, a transformation device for forming transformed feature vectors, and having a subsequent classification unit that classifies the supplied, transformed feature vectors and emits output signals corresponding to the determined classes. A high rate of recognition at a relatively low expenditure for the design and processing are achieved in that the feature extraction device has feature extraction stages separately arranged in the individual channels, the feature extraction stages being connected at their outputs to the shared transformation device.

### FIELD OF THE INVENTION

The present invention relates to a voice recognition device, where at least two input signals are routed in parallel via respective, separate channels to a recognition device having a feature extraction device for forming feature vectors, having a transformation device for forming transformed feature vectors, and having a subsequent classification unit that classifies the supplied, transformed feature vectors and emits output signals corresponding to the determined classes.

### BACKGROUND INFORMATION

In modern systems for automatic voice recognition, an attempt is often made to improve the recognition performance of a fundamental classification unit by linearly transforming extracted features. The transformation is selected in such a manner that, on the one hand, the dimension of the feature space is reduced, but, on the other hand, as much class-separating information as possible is retained. For this purpose, linear discriminant analysis is often used as is more closely described, for example, in R. Haeb-Umbach, H. Ney: Linear Discriminant Analysis for Improved Large Vocabulary Continuous Speech Recognition. In: Proceedings of the International Conference on Acoustics, Speech & Signal Processing (ICASSP). 1. 1992, pp.13-16; M. Finke, P. Geutner, H. Hild, T. Kemp, K. Ries, M. Westphal: The Karlsruhe-Verbmobil Speech Recognition Engine. In: Proceedings of the International Conference on Acoustics, Speech & Signal Processing (ICASSP). 1. 1997, pp. 83-86; as well as in G. Ruske, R. Falthauser, T. Pfau: Extended Linear Discriminant Analysis (EL-DA) for Speech Recognition. In: Proceedings of the International Conference on Speech and Language Processing (ICSLP). 1998.

In this context, a reduction of a combined feature vector typically from 39 to 32 components is known. In this context, the original feature vector is formed from the short-time rating of the signal, 12 mel-frequency cepstral coefficients (MFCC), as indicated in S. B. Davis, P. Mermelstein: Comparison of Parametric Representation for Monosyllabic Word Recognition in Continuously Spoken Sentences. IEEE Transactions on Acoustics, Speech, and Signal Processing ASSP-28 (1980), pp. 357-366, and from their first and second time derivative. In this case, the feature extraction uses one single input signal. Typically, the features are calculated for signal blocks having a length of approximately 20 ms. This occurs in a reduced time cycle, about every 10 ms. Such a processing chain is shown in FIG. 3. In this context, the index k designates a large time cycle of a digitalized voice signal, while the index l represent a reduced time cycle of the feature vectors. To differentiate individual classes, the subsequent classification uses so-called hidden Markov models or pattern matching using dynamic time matching (adaptation). Artificial neural networks are also used for classification. In a training phase, these classification units must be adjusted, based on sample data, to the classification task.

However, if a plurality of input signals are available, they are typically combined using a method for multi-channeled reduction of interfering noise into one signal having reduced interfering noise, so that the feature extraction device of the voice recognition device must itself only process one input signal routed thereto. In this context, the methods used for reducing interfering noise utilize the correlation between the signals as stated in J. Allen, D. Berkley, J. Blauert: Multimicrophone signal processing technique to remove room reverberation from speech signals. Journal of the Acoustical Society of America 62 (1977), No. 4, pp. 912-915 and M. Dörbecker, S. Ernst: Combination of Two-Channel Spectral Subtraction and Adaptive Wiener Post-Filtering for Noise Reduction and Dereverberation. In: Proceedings of EUSIPCO. 2. 1996, pp. 995-998, or the directional effect of so-called microphone arrays, as in M. Dörbecker: Small Microphone Arrays with Optimized Directivity for Speech Enhancement. In: Proceedings of the European Conference on Speech Communication and Technology (EURO-SPEECH). 1. 1997, pp. 327-330 and J. Bitzer, K. U. Simmer, K. D. Kammeyer: Multi-Microphone Noise Reduction Techniques for Hands-Free Speech Recognition—A Comparative Study.

In: Proceedings of the Workshop on Robust Methods for Speech Recognition in Adverse Conditions. 1999, pp. 171-174. These methods function either in a frequency range having approximately 128 to 512 frequency bands or by filtering the input signals in the time interval. These approaches require a high level of computing power, in particular in the case of real-time implementation, since large amounts of data are generated for computing. The reduction to few features occurs first after the input signals are combined.

### SUMMARY OF THE INVENTION

An object of the present invention is to provide a voice recognition device requiring the lowest expenditure possible with respect to its design and processing performance for the highest possible rate of recognition.

According to the present invention, the feature extraction device has feature extraction stages arranged separately in the individual channels, the feature extraction stages being connected at their outputs to the shared transformation device.

As a result of this design of the voice recognition device and the thus-implemented procedure, the input signals in the individual channels directly undergo the feature extraction. In this context, as much information as possible for the recognition process is to flow in from the input signals into the extracted feature vector. The channels are first combined in the feature space, a single transformed feature vector being calculated from the feature vectors of the individual channels. Thus, the feature vectors are calculated independently of one another from the input signals and are combined using a transformation to form a common feature vector.

While the voice recognition device is in operation, the feature vectors are combined by a simple time-invariant matrix operation. In contrast to the known adaptive method of the multi-channeled reduction of interfering noise, this method results in a significant reduction in the computational expenditure. Firstly, for the developed method, it is not necessary to adapt during operation, and secondly, the reduction to few features and to a reduced time cycle occurs prior to the channels being combined.

In response to the voice recognition device being trained under the conditions of a designated operation situation, without interference noise reduction, on the one hand, and in response to the voice recognition device being used in a corresponding real situation, also without interference noise reduction, on the other hand, it has surprisingly been shown that there is a higher rate of recognition than in response to using interference noise reduction during training and real use. If for any reason the interference noise is reduced during training and real use, this can be performed relatively easily prior to the feature extraction, in the individual channels, i.e., per channel, without significant additional expenditure.

One advantageous embodiment of the voice recognition device is that the transformation device is a linear transformation device. In this context, suitable measures are that the transformation device is designed to perform a linear discriminant analysis (LDA) or a Karhunen-Loève transform.

Selecting the transformation device for the development of the voice recognition unit results in the most information possible being retained for differentiating the different classes. When using the linear discriminant analysis or the Karhunen-Loève transform, sample data is necessary for the design of the transformation device. It is favorable to use the same data used in designing the classification unit.

There are also expansions of the LDA that can be used here. Moreover, it is conceivable to select non-linear transformation devices (e.g. so-called “neural networks”). These methods have in common that sample data is required for the design.

The rate of recognition is further supported in that the classification unit is trained under conditions corresponding to a designated application situation.

### BRIEF DESCRIPTION OF THE DRAWINGS

FIG. 1 shows a block diagram of a two-channeled voice recognition device.

FIG. 2 shows a block diagram of a multi-channeled voice recognition device.

FIG. 3 shows a one-channeled voice recognition device according to the related art.

### DETAILED DESCRIPTION

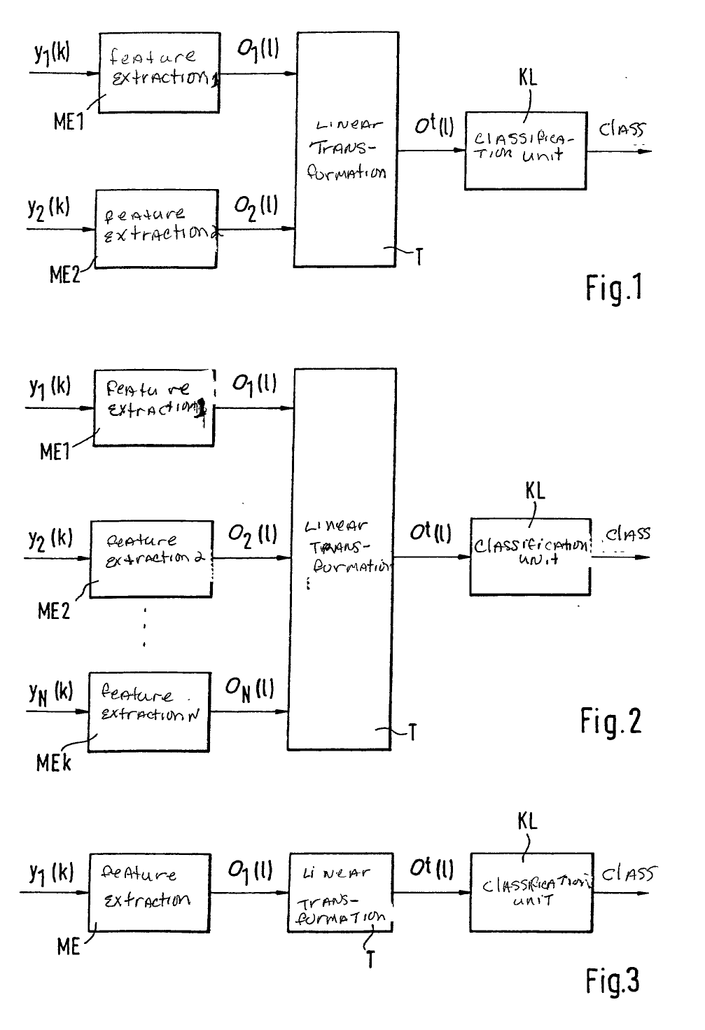

FIG. 1 shows a block diagram of a developed voice recognition device and a corresponding method, respectively, in a two-channeled embodiment, i.e., including two input signals y₁ and y₂. Using known methods of extracting features, e.g. MFCC, feature vectors O₁ and O₂ are separately acquired per channel from input signals y₁ and y₂. A new sequence of transformed feature vectors is formed from the sequence of these feature vectors by a preferably linear operation according to the relationship:

$${O}^{t} ( l ) = T \cdot [ \begin{matrix}{O}_{1} ( l ) \\ {O}_{2} ( l )\end{matrix} ] \qquad ( 1 )$$

The matrix operation is performed for every signal block in a reduced time cycle 1. The dimension of matrix T is accordingly selected to cause a reduction in the dimension. If both feature vectors U₁ and U₂ possess n₁ and/or n₂ components, respectively, and if the transformed feature vector is only to include nₜ coefficients, matrix T must have dimension nₜ times (n₁+n₂). A typical numerical example is n₁=39, n₂=39, and nₜ=32. Then transformation matrix T has the dimension 32*78, and the transformation results in the dimension being reduced from a total of 78 components in feature vectors O₁ and O₂ to 32 components in transformed featured vector O^{t.}

Based on sample data, transformation matrix T is adjusted so that transformed feature vector O^{t} has the maximum amount of information for differentiating the individual classes. For this purpose, it is possible to use the known methods of linear discriminant analysis or the Karhunen-Loève transform. Transformed feature vectors O^{t}(l) are used for training classification unit KL.

As shown in FIG. 2, more than two channels can also be combined with one another as an expansion of the present method. Equation 1 then becomes:

$${O}^{t} ( l ) = T \cdot [ \begin{matrix}{O}_{1} ( l ) \\ ⋮ \\ {O}_{N} ( l )\end{matrix} ] \qquad ( 2 )$$

The dimension of the transformation matrix is then nₜ x (Σᵢ₌ₗ ^{N}nₜ), nᵢ indicating the number of components in feature vector O_{l.}

The blocks ME1, ME2, MEk, indicated in FIGS. 1 and 2, of the feature extraction stages, which are allocated to the respective channels, and which form the feature extraction device, do not necessarily have to be the same for all input signals y₁, y₂, and y_{N}, respectively. For example, features based on the so-called linear prediction, which is also used in voice coding, are possible as alternatives.

What is claimed is:

1. A voice recognition device comprising:
a feature extraction device for receiving a plurality of input signals routed in parallel via a plurality of respective, separate channels, the feature extraction device including a plurality of feature extraction stages, each of the plurality of feature extraction stages being separately situated in a respective one of the plurality of separate channels and each having a respective output for providing a respective feature vector;
a shared transformation device coupled to the outputs of the feature extraction stages, the transformation device forming transformed feature vectors; and
a classification unit for classifying the transformed feature vectors provided by the transformation device and providing at least one output signal corresponding to at least one determined class.

2. The voice recognition device according to claim 1, wherein the transformation device is a linear transformation device.

3. The voice recognition device according to claim 1, wherein the transformation device performs one of a linear discriminant analysis and a Karhunen-Loève transform.

4. The voice recognition device according to claim 1, wherein the transformation device depends upon sample data.

5. The voice recognition device according to claim 1, wherein the classification unit is trained under conditions corresponding to a designated application situation.

6. The voice recognition device according to claim 1, further comprising interference noise reduction stages allocated to each of the feature extraction stages, the interference noise reduction stages being connected in series.
